(19) United States
(12) Patent Application Publication
(10) Pub. No.: US 2017/0265681 A1
(43) Pub. Date: Sep. 21, 2017

(54) HOT DOG ROLLER GRILL

(71) Applicant: ROUND SHINE INDUSTRIAL CO., LTD., NEW TAIPEI CITY (TW)

(72) Inventor: JUI-MING LEE, NEW TAIPEI CITY (TW)

(21) Appl. No.: 15/257,222

(22) Filed: Sep. 6, 2016

(30) Foreign Application Priority Data
Mar. 18, 2016 (TW) 105203838

(51) Int. Cl. A47J 37/04

(52) U.S. Cl. CPC A47J 37/048

(57) ABSTRACT

A hot dog roller grill includes a machine body, a plurality of heating rollers and a plurality of temperature-sensing assemblies. The heating rollers are rotationally pivotally mounted to the machine body. Each of the temperature-sensing assemblies is mounted to one end of a specific heating roller.

This application claims the benefit of Taiwan Patent Application Serial No. 105203838, filed Mar. 18, 2016, the subject matter of which is incorporated herein by reference.

### BACKGROUND OF INVENTION

1. Field of the Invention

The invention relates to a food processing apparatus, and more particularly to a hot dog roller grill.

2. Description of the Prior Art

With rapid development in knowledge economics, people's life styles change as well. The pace of life nowadays becomes tense and busy. Definitely, efficiency and punctuality become normal disciplines to people. Hence, a rapid and simple diet style becomes popular. Actually, a large majority of people live on ready-to-eat delis in convenient stores, such as buns, steamed breads, hot dogs, baked breads, chawanmushi and so on.

Among all the aforesaid ready-to-eat delis, the hot dogs could be one of the popular foods in the convenient stores. To prepare or cook the hot dogs in a convenient store, a hot dog roller grill as an all-time-ready device is usually applied to bake a number of the hot dogs at the same time. The operation theory of the hot dog roller grill is to heat electrically the food (hot dogs for example) on rotational rollers. However, due to practical difficulty in detecting temperatures of the rollers, the function of real-timely adjusting temperatures of the rollers can be provided anyway by the conventional hot dog roller grill. Therefore, in the case that the temperature of the rollers is too high, part of the foods (hot dogs for example) on the rollers would be burned, exploded or over baked, and thus appearances of the foods to be sold would be ugly. On the other hand, in the case that the temperature of the rollers is too low, the foods (hot dogs for example) to be cooked wouldn't be well done. If the un-done foods are stayed too long on the rollers, and then ruin or fatigue of the foods would be possible.

### SUMMARY OF THE INVENTION

Accordingly, it is the primary object of the present invention to provide a hot dog roller grill that can adjust the temperature of the rollers in a real-time manner, such that a constant heating temperature can be provided, and the unexpected situation of too high or too low temperature can thus be avoided.

In the present invention, the hot dog roller grill includes a machine body, a plurality of heating rollers and a plurality of temperature-sensing assemblies. The heating rollers are rotationally pivotally mounted to the machine body. Each of the temperature-sensing assemblies is mounted to one end of a specific heating roller.

In one embodiment of the present invention, the temperature-sensing assembly includes a temperature-sensing collar and a temperature-sensing bar. The temperature-sensing collar sleeves one end of the corresponding heating roller. The temperature-sensing bar is connected with the temperature-sensing collar.

In one embodiment of the present invention, the machine body includes a base, a first lateral member and a second lateral member. The first lateral member and the second lateral member are located to opposing sides of the base, respectively, and the plurality of heating rollers are located between the first lateral member and the second lateral member and above the base by a space.

In one embodiment of the present invention, the hot dog roller grill further includes a temperature-control panel located at the base.

In one embodiment of the present invention, each of the heating rollers includes a hollow roller body and an electric heating pipe mounted inside the roller body.

In one embodiment of the present invention, the hot dog roller grill further includes an oil-seal bushing sleeving the roller body.

By providing the hot dog roller grill of the present invention, the foods (hot dogs for example) can be turned and heated by the heating rollers, the temperature of the heating rollers can be detected by the temperature-sensing assembly, and thus the temperature of the heating rollers can be adjusted in a real-time manner.

All these objects are achieved by the hot dog roller grill described below.

### BRIEF DESCRIPTION OF THE DRAWINGS

The present invention will now be specified with reference to its preferred embodiment illustrated in the drawings, in which:

FIG. 1 is a perspective view of a preferred embodiment of the hot dog roller grill in accordance with the present invention;

FIG. 2 is a largely exploded view of FIG. 1;

FIG. 3 shows a portion of FIG. 2; and

FIG. 4 shows a heating roller and a temperature-sensing assembly for the hot dog roller grill of FIG. 1.

### DESCRIPTION OF THE PREFERRED EMBODIMENT

The invention disclosed herein is directed to a hot dog roller grill. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

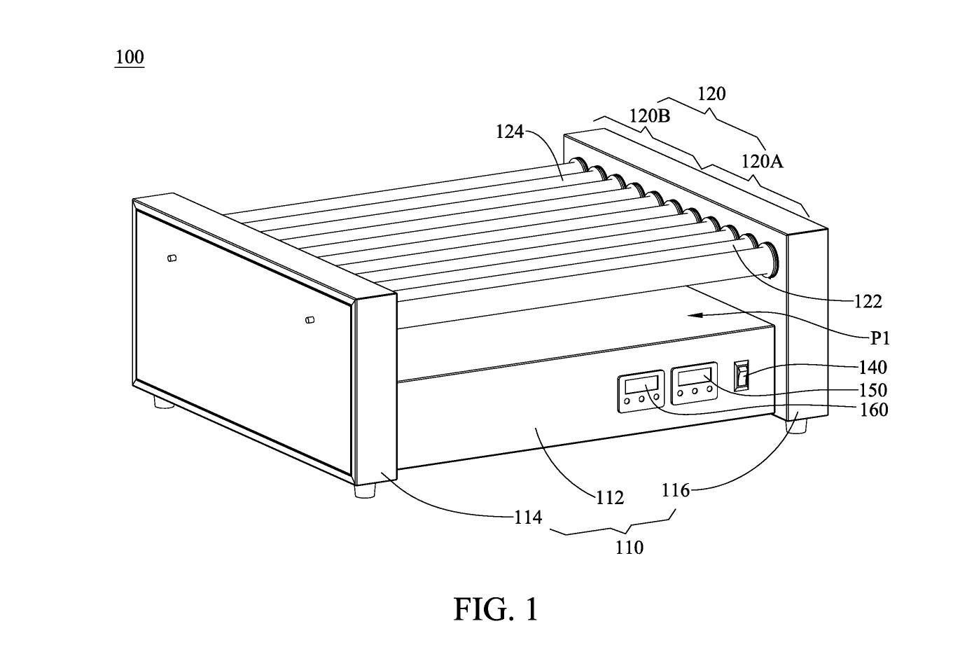

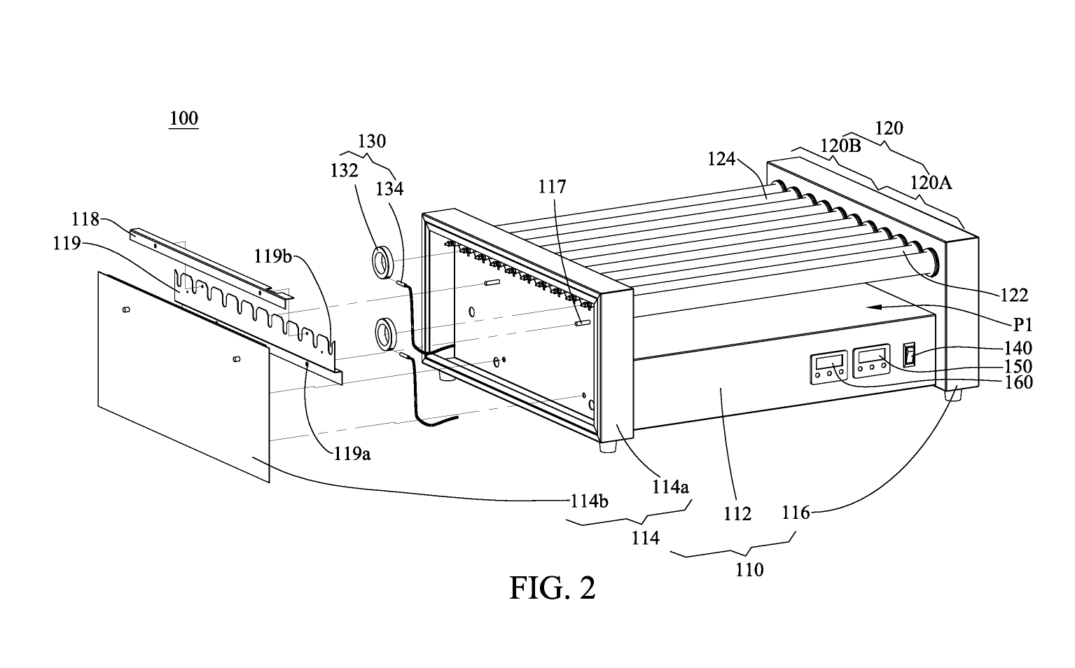

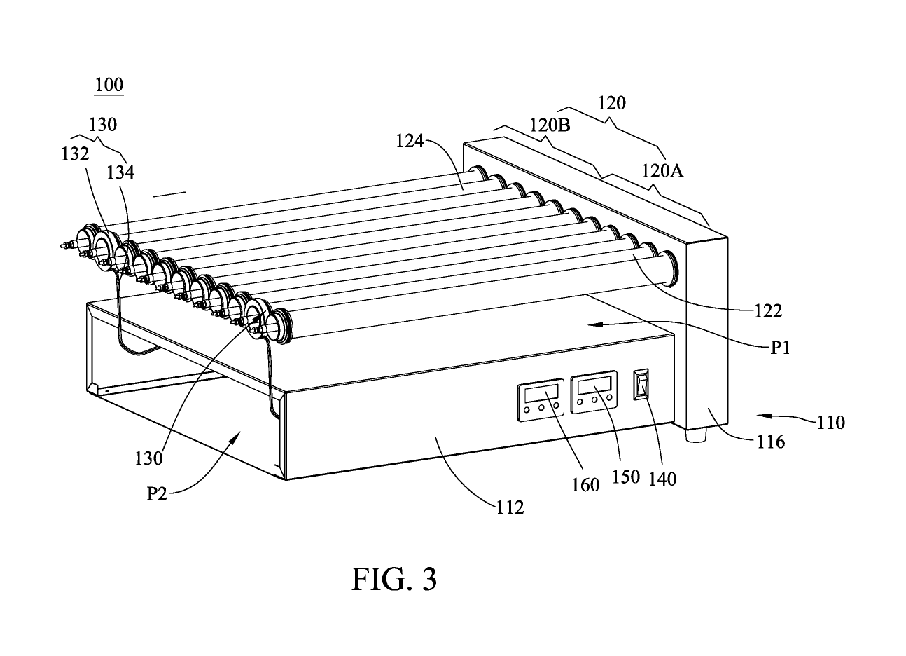

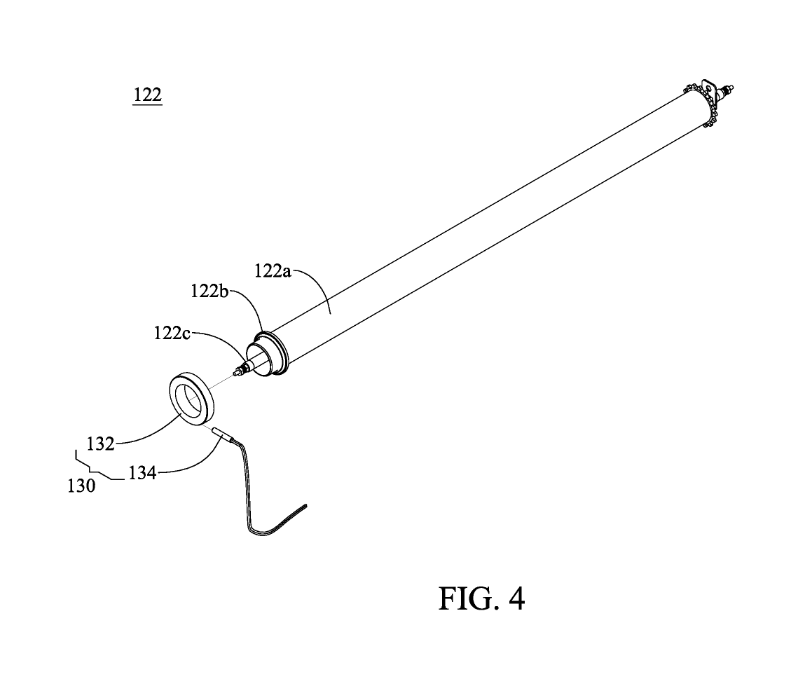

Refer now to FIG. 1 to FIG. 4; where FIG. 1 is a perspective view of a preferred embodiment of the hot dog roller grill in accordance with the present invention, FIG. 2 is a largely exploded view of FIG. 1, FIG. 3 shows a portion of FIG. 2, and FIG. 4 shows a heating roller and a temperature-sensing assembly for the hot dog roller grill of FIG. 1. in this embodiment, the hot dog roller grill 100 includes a machine body 110, a plurality of heating rollers 120, a plurality of temperature-sensing assemblies 130, a switch 140, a first temperature-control panel 150 and a second temperature-control panel 160.

The machine body 110 includes a base 112, a first lateral member 114 and a second lateral member 116. The first lateral member 114 and the second lateral member 116 are located to opposing sides of the base 112, respectively. The heating rollers 120 arranged in a parallel manner are located between the first lateral member 114 and the second lateral member 116. The base 112 is located under the heating rollers 120 by a space P1.

The base 112 is shaped as a hollow rectangular box having an internal accommodation room P2.

In detail, the first lateral member 114 includes a rectangular frame structure 114a and an end plate 114b. The end plate 114b is fixed onto the frame structure 114a. The frame structure 114a further includes thereinside a first assembly component 117, a second assembly component 118 and a third assembly component 119.

The first assembly component 117 can be a weld screw located on an inner wall of the frame structure 114a for engaging the end plate 114b.

The second assembly component 118 can be a bent plate trip having assembly holes and cutouts for assembly purposes.

The third assembly component 119 can be another bent plate structure having assembly holes 119a and parallel cutouts 119b, in which the parallel cutouts 119b are located along an edge (the top side in the figure) of the third assembly component 119.

In assembling the first lateral member 114, the assembly holes 119a of the third assembly component 119 is matched to engage the first assembly component 117, the second assembly component 118 is fixed to the third assembly component 119 by relevant fasteners, and the end plate 114b is then applied to cover the frame structure 114a.

The second lateral member 116 and the first lateral member 114 are structurally identical at large. The second lateral member 116 also includes a rectangular frame structure and an end plate, where the end plate is fixed onto the frame structure. The major difference between the second lateral member 116 and the first lateral member 114 is that the second lateral member 116 includes a transmission unit (not shown in the figure) of the hot dog roller grill for rolling the heating rollers. The transmission unit can be, but not limited to, a combination of a motor, a sprocket wheel and a chain.

In this embodiment, a plurality of heating rollers 120 can be rotationally pivoted to the machine body 110, the temperature-sensing assembly 130 is located to one end of each of the heating rollers 120. Another end of each of the heating rollers 120 (the end close to the second lateral member 116) is mounted by a sprocket wheel. A chain is connected to each of the sprocket wheels. The motor is to drive the chain so as to rotate synchronously the sprocket wheels as well as the corresponding heating rollers 120. All the heating rollers 120 can thus rotate horizontally in the same direction, so that the hot dogs or other foods on the rollers 120 can be turned and heated at the same time.

Practically, the plurality of the heating roller 120 is connected between the first lateral member 114 and the second lateral member 116 in a removable manner. The heating rollers 120 can be grouped into a front heating area 120A and a rear heating area 120B, in which the front heating area 120A can be a temperature-keeping area for resting the well-done foods (hot dogs for example), and the rear heating area 120B can be a high-temperature area for heating or pre-heating the foods (hot dogs for example). For example, in this embodiment, 11 heating rollers 120 are included. The front heating area 120A can include 6 parallel heating rollers 122, and the spacing between two neighboring heating rollers 122 is smaller than an outer diameter of the food (hot dog for example).

As shown in FIG. 4, the heating roller 122 includes a roller body 122a, an oil-seal bushing 122b and an electric heating pipe 122c. The hollow roller body 122a can be made of a thermal conductive metal. The oil-seal bushing 122b sleeves the roller body 122a. The electric heating pipe 122c is located inside the roller body 122a.

The temperature-sensing assembly 130 includes a temperature-sensing collar 132 and a temperature-sensing bar 134. The temperature-sensing collar 132 sleeves one end of the heating roller 122 by closing to the oil-seal bushing 122b. The temperature-sensing bar 134 is connected with the temperature-sensing collar 132. In this embodiment, the temperature-sensing bar 134 can be an electronic controllable temperature-sensing bar. In addition, as shown in FIG. 2, a plurality of parallel cutouts are located at an inner wall of the frame structure 114a so as to allow wiring of the corresponding temperature-sensing bars 134 to penetrate the respective parallel cutouts and then to be sorted into the accommodation room P2 of the base 112.

The rear heating area 120B can include 5 parallel heating rollers 124. Each of the heating rollers 124 in this area 120B includes a roller body, an oil-seal bushing and an electric heating pipe. The structuring and the arrangement of the temperature-sensing assembly for the heating roller 124 are identical to those for the heating roller 122, and thus details thereabout would be omitted herein. In addition, the spacing between any two neighboring heating rollers 124 is smaller than the diameter of the food thereon (hot dogs for example). In the present invention, the front heating area 120A and the rear heating area 120B are two independent heating areas, but the numbers of the heating rollers in different heating areas for the present invention are determined per different requirements, not necessarily limited to the aforesaid embodiment.

It shall be noted is that, in this embodiment, only two temperature-sensing assemblies 130 are included. One is located at one end of one heating roller 122 in the front heating area 120A, while another one is located at one end of one heating roller 124 in the rear heating area 120B. Namely, the temperature of each heating roller 122 in the front heating area 120A is detected by the temperature-sensing assembly 130 in the front heating area 120A, and the temperature of each heating roller 124 in the rear heating area 120B is detected by another temperature-sensing assembly 130 in the rear heating area 120B. It is not required to construct a temperature-sensing assembly to each heating roller, so that the manufacturing cost can be controlled. However, the number and the arrangement of the temperature-sensing assemblies for the heating rollers are determined per different requirements, not necessarily limited to the aforesaid embodiment.

The switch 140, the first temperature-control panel 150 and the second temperature-control panel 160 are constructed at the base 112. The switch 140 is to activate the hot dog roller grill 100. The first temperature-control panel 150 corresponding to the front heating area 120A is to adjust the temperature of the heating rollers 122 in the front heating area 120A, while the second temperature-control panel 160 corresponding to the rear heating area 120B is to adjust the temperature of the heating rollers 124 in the rear heating area 120B. It shall be noted that, in this embodiment, the front heating area 120A and the rear heating area 120B are attributed to the first temperature-control panel 150 and the second temperature-control panel 160, respectively. However, in other embodiment, the number of the panels can be varied per practical requirements.

In summary, in the hot dog roller grill of the present invention, while the switch is triggered to activate the hot dog roller grill, then the motor drives the chain to rotate the heating rollers synchronously in the same direction, such that the foods (hot dogs for example) thereon can thus be turned and heated. Further, by providing the temperature-sensing assemblies, the temperatures of the heating rollers can be detected. In case if a temperatures is detected to be too high, too low or abnormal by the temperature-sensing assembly, the corresponding temperature-control panel can be applied to adjust in time the temperatures of the corresponding heating rollers, so that the temperature states of the foods (hot dogs for example) on the hot dog roller grill can be controlled.

In addition, in a conventional heating switch consisted of a bi-metal plate and a quick-response component (i.e. a high quality switch spring with contact points), when the switch is turned on, the bi-metal plate is heated to deform and so as further to trigger the corresponding contact point. When a control shaft is rotated to change its position, then an internal cam would vary a distance between the bi-metal plate and the corresponding contact point, and thus the distance would determine the timing to open or close the circuit so as to adjusting the heating time. Such a conventional heating switch can precisely judge the temperature of the rollers, and the performance thereof is highly affected by the fatigue of the bi-metal plate (resulting in a bias to each scale of rotations). Hence, the real temperature for the rollers would be deviated from the expected temperature by the user. Contrarily, the hot dog roller grill of the present invention introduces the temperature-sensing assembly able to adjust the temperature of the heating rollers in a real-time manner, so that a constant temperature for the rollers can be obtained after a specific heating process. Namely, the hot dog roller grill provided by the present invention can maintain the heating rollers at a specific temperature.

For example, in the 5 heating rollers at the rear heating area, one of the heating rollers is mounted with the temperature-sensing assembly by sleeving the temperature-sensing collar onto the heating roller. Then, the temperature-sensing bar can detect the real temperature of the heating roller. As the temperature of the heating roller reaches a preset heating temperature, then the electric heating pipe would terminate the heating. As the temperature of the heating roller is down below a predetermined temperature, the electric heating pipe is activated again to heat the heating roller till the temperature of the heating roller reaches the preset heating temperature again. Under such an arrangement, the temperature of the heating roller can be controlled and adjusted in a real-time manner within a specific temperature domain. Further, since the heating roller can be substantially maintained at a constant temperature range, the foods (hot dogs for example) turned and heated on the heating rollers can be evenly cooked, and thus quality deli for the users can be met.

While the present invention has been particularly shown and described with reference to a preferred embodiment, it will be understood by those skilled in the art that various changes in form and detail may be without departing from the spirit and scope of the present invention.

What is claimed is:

1. A hot dog roller grill, comprising:
a machine body;
a plurality of heating rollers, rotationally pivotally mounted to the machine body; and
a plurality of temperature-sensing assemblies, each of the plurality of temperature-sensing assemblies being mounted at one end of corresponding one of the plurality of heating rollers.

2. The hot dog roller grill of claim 1, wherein the temperature-sensing assembly includes:
a temperature-sensing collar, sleeving one end of the corresponding heating roller; and
a temperature-sensing bar, connected with the temperature-sensing collar.

3. The hot dog roller grill of claim 1, wherein the machine body includes:
a base; and
a first lateral member and a second lateral member, located to opposing sides of the base respectively, the plurality of heating rollers being located between the first lateral member and the second lateral member and above the base by a space.

4. The hot dog roller grill of claim 3, further including:
a temperature-control panel, located at the base.

5. The hot dog roller grill of claim 1, wherein each of the heating rollers includes:
a hollow roller body; and
an electric heating pipe, mounted inside the roller body.

6. The hot dog roller grill of claim 5, further including:
an oil-seal bushing, sleeving the roller body.
